(19) United States
(12) Patent Application Publication
(10) Pub. No.: US 2005/0278414 A1
(43) Pub. Date: Dec. 15, 2005

(54) Method for marketing a firm

(76) Inventors: Joseph Richard Condo, Lumberton, NJ (US); Suzanne Elizabeth Miller, Ocala, FL (US); Tracy Renee Reduzzi, Pen Argyl, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/854,979

(22) Filed: May 27, 2004

(51) Int. Cl. G06F 15/16

(52) U.S. Cl. 709/202; 709/206

(57) ABSTRACT

An electronic copy of an issued intellectual property (IP) is stored on a web server and presented on a web site associated with the IP firm. An email notification is also provided, wherein the email notification has a link to either the web site or to the electronic copy, a notification that the IP has issued, and text that identifies the IP firm. An email message for marketing an IP firm is also provided. The email message comprises text which is associated with generalized IP information and inserted into the email message by way of a predefined email template or signature. The message also comprises text associated with an issued IP, a link to either a web site associated with the IP firm or to an electronic copy of the issued IP, and additional text associated with the IP firm.

### FIELD OF THE INVENTION

The present invention relates to a method for marketing an intellectual property firm. More particularly, the present invention relates to a method of generating and sending an electronic notification that an intellectual property has issued and for providing a link to an Internet site at which an indicia of the intellectual property may be viewed or retrieved.

### BACKGROUND OF THE INVENTION

Firms that engage in the acquisition of intellectual property (IP) such as patents, trademarks, copyrights, and the like, typically have limited opportunities to market themselves to potential clients. For example, mass mailings are expensive and of limited effectiveness, and professional decorum prevents most respected firms from more aggressive forms of marketing.

With the advent of the Internet, many IP firms have established web sites as a way to market themselves to the public. On such a web site, an IP firm may provide information about the services offered by the firm, biographical information about the members of the firm, links to Internet resources, and so forth. Conventional IP firm web sites, however, lack the ability to actively attract Internet traffic.

The issuance of an intellectual property is a significant accomplishment on the part of an IP firm and its client. The process of obtaining an IP is both time-consuming and confusing to the uninitiated, and requires a great deal of skill on the part of the IP firm, as well as on the part of the client in developing the IP. Unfortunately, the issuance of an IP is an event that takes place in relative obscurity. For example, an IP office such as the U.S. Patent and Trademark Office usually only notifies the IP firm that is prosecuting a particular application that the application has been allowed and will be issued as a patent. The IP firm may forward any such issuance information to its client, but in many cases the publicity surrounding the issuance of the IP ends at that point.

Electronic indicia of issued IP, such as electronic copies patents, for example, are available on both government (e.g., www.uspto.gov) and commercial (e.g., www.lexis.com) websites. Most members of the public, such as potential clients and so forth, are not familiar with such sites, or the IP process in general. Thus, in the normal course of events, the IP issues and very few people are informed about it. Therefore, the firm is unable to take advantage of the event to market its services. It would be advantageous for such firms if a convenient way existed to utilize the issuance of the IP to market itself and its expertise. In that regard, it would be highly advantageous for such firms if there existed a way to tie the issuance of an IP to, for example, the firm's web site, thereby generating publicity regarding the IP, while at the same time generating publicity about the firm. As such, the firm could provide a service to the interested public by informing interested parties of the patent issuance, and would have an opportunity to market itself further to its existing clients or to potential new clients.

A method for generating a notification for announcing the issuance of an IP would therefore be desirable. More particularly, such a method would be especially desirable if such a method included retrieving an electronic indicia of an issued IP and storing it on a web server associated with an IP firm's website, and then providing a link to the web site and/or electronic copy by way of an email message. Even more particularly, what is needed is a method of using an email program template or signature to generate an email that, in some fashion, identifies the IP firm.

### SUMMARY OF THE INVENTION

In light of the above shortcomings, a method for marketing an IP firm is provided. In the method, an electronic indicia of an issued intellectual property (IP) is stored on a web server and presented on a web site associated with the IP firm. An email notification is also provided, wherein the email notification has a link to either the web site or to the electronic copy, a notification that the IP has issued, and text that identifies the IP firm.

In addition, an email message for marketing an IP firm is provided. The email message comprises text which is associated with generalized IP information and inserted into the email message by way of a predefined email template or signature. The message also comprises text associated with an issued IP, a link to either a web site associated with the IP firm or to an electronic copy of the issued IP. Finally, the email comprises additional text associated with the IP firm.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram illustrating an exemplary computing environment in which aspects of the invention may be implemented;

FIG. 2 is flowchart illustrating a method for generating an email in accordance with an embodiment of the present invention;

FIGS. 3A-B are screen shots illustrating exemplary steps of creating a template in accordance with an embodiment of the present invention;

FIGS. 4A-F are screen shots illustrating an exemplary method of generating an email using a template in accordance with an embodiment of the present invention;

FIGS. 5A-B are screen shots illustrating an exemplary use of an email signature to generate an email in accordance with an embodiment of the present invention; and

FIGS. 6A-D are screen shots illustrating an exemplary creation of an email signature in accordance with an embodiment of the present invention.

FIGS. 7A-B are screen shots illustrating the creation of a link to an electronic indicia of an issued intellectual property.

### DETAILED DESCRIPTION OF ILLUSTRATIVE EMBODIMENTS

As noted above, an embodiment of the present invention is directed to a method of creating and sending an email that provides a marketing function for an intellectual property (“IP”) firm. By “IP” it is meant patents, trademarks, copyrights, and the like. By “IP firm” it is meant any firm that handles intellectual property matters in whole or in part, such as dedicated IP firms or firms with an IP group or department.

Within the email is generalized and specific IP information, as well as a link. The link may be to an electronic copy or other electronic indicia of an issued IP, which may be attached to the email or stored on a web server associated with the IP firm. Alternatively, the link may be to a web site associated with the IP firm. By directing a recipient of the email in such a manner, the IP firm gains exposure in the marketplace. As may be appreciated, in one embodiment the selection of email recipients is made so as to target people or organizations that are interested in the issued IP such as, for example, the inventor(s), assignee(s), and so forth. In another embodiment, the selection of email recipients is made based on the IP firm's assessment of potentially interested parties such as, for example, potential clients who may wish to review the IP firm's work and read more about the firm. By receiving the email, such potentially interested party can see an issued IP that was drafted by the firm, as well as read any additional information that may be available on the web site.

From the discussion that follows, it will be appreciated that the present invention is not limited solely to the marketing of IP firms, and use by other types of firms (such as, for example, real estate, securities, corporate, labor, tax, trust and estates, etc.) using electronic indicia relevant to their practice areas is also within the scope of the invention. Such uses will be readily apparent once armed with the present disclosure.

In the discussion that follows, it will be appreciated that such an email may be sent from a dedicated email account, or an individual or group within the firm may send the email. As will also be discussed below, an email template or signature, or the like, may be created to contain generalized IP information. In such a manner, the common elements of an IP do not need to be entered every time an email is to be sent.

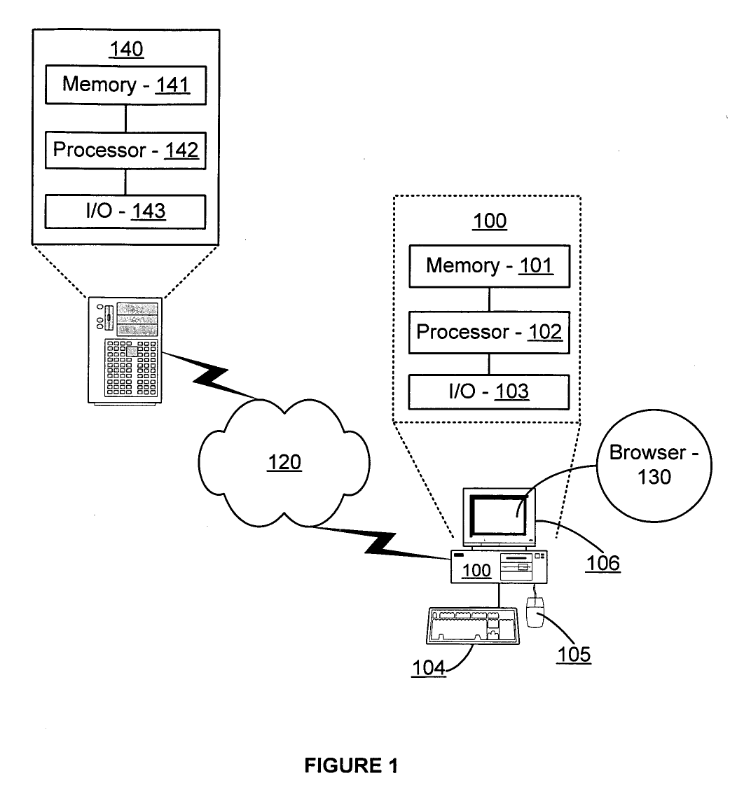

Turning now to FIG. 1, an exemplary computing environment in which aspects of the present invention may be implemented is illustrated. Computer 100 may be any general purpose or specialized computing device capable of performing the methods discussed herein. In one embodiment, computer 100 comprises memory 101 for storing data, a processor 102 for data processing and input/output (I/O) 103 for communicating with a network 120 and/or another communications medium such as a telephone line or the like. It will be appreciated that memory 101 may be, for example, RAM, ROM, a hard drive, CD-ROM, USB storage device, and the like. In addition, memory 101 may be located internal or external to computer 100. Processor 102 of computer 100 may be a single processor, or may be a plurality of interconnected and/or specialized processors. I/O 103 may be any hardware and/or software component that permits a user or external device to communicate with computer 100. For example, in one embodiment I/O 103 operatively connects the computer 100 to the network 120. The network 120 is any system of interconnected computing devices such as, for example, the Internet, an intranet and the like.

In one embodiment of the present invention, computer 100 also comprises one or more input devices such as, for example, a keyboard 104 and a mouse 108. It will be appreciated that any number and type of input devices may be used in connection with a computer 100 while remaining consistent with an embodiment of the present invention. For example, the computer 100 may receive input from devices such as a microphone, USB device and the like. As can be seen in FIG. 1, computer 100 also comprises a display device 106. Such a display device may be a computer monitor (CRT, flat screen or the like), LCD display, and so forth. In an embodiment, a browser 130 such as an Internet browser is displayed on the display device 106 by the computer 100. Such a browser 130 enables a user to interact with a web page that is retrieved from, for example, the Internet, an intranet or the like.

It will be appreciated that in some embodiments the computer 100 will be a desktop computer 100 as illustrated in FIG. 1, while in other embodiments the computer 100 may be another type of device. For example, computer 100 may be a notebook computer, personal digital assistant (PDA), cellular phone or the like that is adapted to access the network 120. Accordingly, any type of device having the functionality of computer 100 as shown in FIG. 1 is equally consistent with an embodiment of the present invention.

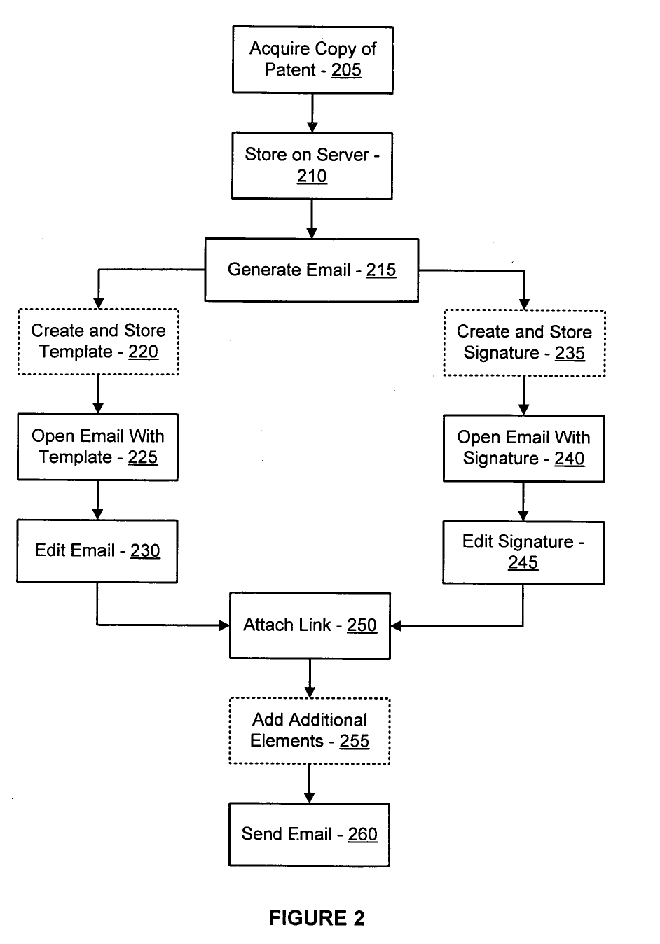

The server 140 is a computing device that is adapted to present a web page or the like by way of the network 120. Like the computer 100, the server 140 comprises a memory 141, a processor 142 and an I/O 143, which have characteristics similar to those explained above in connection with the memory 101, processor 102 and I/O 103, respectively. In fact, server 140 may be a computer 100 that is performing the functions of a web server. It will be appreciated that additional computers 100 and/or servers 140 may be connected to the network in accordance with an embodiment of the present invention. For example, a first computer 100 may perform the steps of generating an email as will be discussed below in connection with FIG. 2, while a second computer 100 may be used by a recipient of the email to read the text of the email and/or to activate the link and view the IP or an IP firm web site on a second display device 106.

Thus, a network and devices in which aspects of the present invention may be implemented is described. Turning now to FIG. 2, a method for generating an email in accordance with an embodiment of the present invention is illustrated. At step 205, an electronic copy of an issued IP is obtained. It will be appreciated that any manner of acquiring such a copy is consistent with an embodiment of the present invention. For example, such a copy may be acquired from the U.S. Patent and Trademark Office (USPTO), a foreign IP office, a commercial website or other commercial provider. Also, it will be appreciated that any electronic format of such a copy is equally consistent with an embodiment of the present invention. For example, the copy may be in the form of a word processing document, a .pdf file, a html file or the like.

At step 210, the electronic copy is stored on a web server, such as server 140 as discussed above in connection with FIG. 1. The electronic copy may also be made available via a web site provided by the IP firm. As may be appreciated, the electronic copy may be made available on a web page as a link to a file containing the copy, or the copy may be displayed on the web page in any manner by which the indicia may be accessed by the recipient of the notification or, optionally, by the general public as well. At step 215, a determination is made as to which method will be employed to generate an email to send to predetermined people and/or organizations to announce the issuance of the IP. If the email will be generated using an email template, the method proceeds to steps 220-230. If the email is to be generated using an email signature, the method proceeds to steps 235-245.

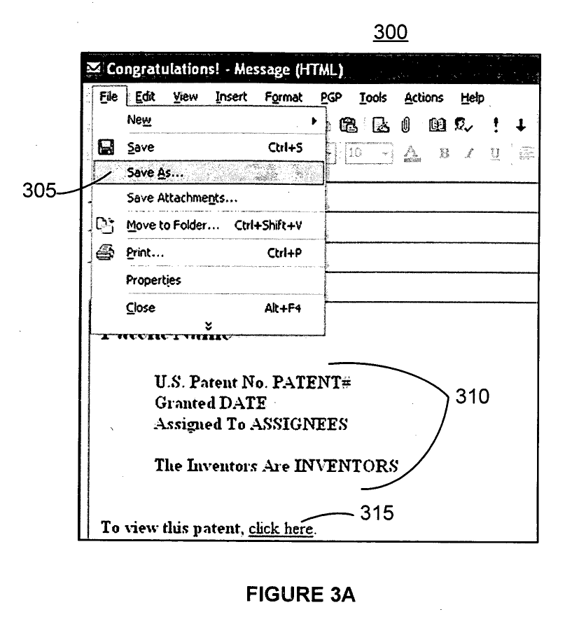

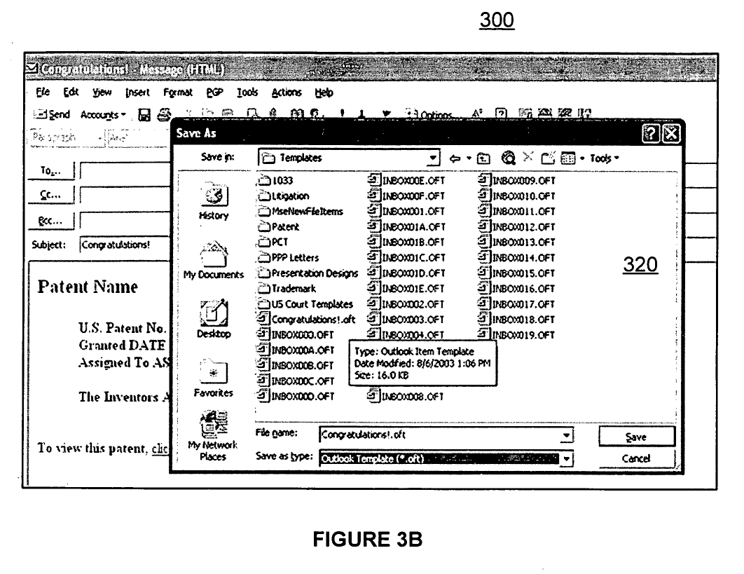

At step 220, an email template is created and stored. Details of an exemplary procedure of creating and storing a template is discussed below in connection with FIGS. 3A-B. As may be appreciated, and as denoted by the dotted line surrounding the block representing step 220 in FIG. 2, step 220 need only be performed once, so as to create a template. Once the template is created, step 220 may be skipped and instead the already-created template may be selected and/or edited. As may also be appreciated, an existing template may need to be modified or replaced, so step 220 may be performed even after a template is created. The template, in one embodiment, contains generalized IP information.

The template may contain fields related to the IP name, IP creator, and IP issue date. The IP name may be, for example, the patent, trademark, or copyright number, the title of the invention, the mark, the title of the work, etc. The IP creator may be the name of the inventor, author, registrant, user, assignee, or owner of the IP, for example. The IP issue date may be, for example, the date the IP is published, granted, given legal force, becomes enforceable, becomes available to the public, etc. For example, when the IP is an issued patent, the template may contain fields such as “Patent Number,” “Inventor Name(s),” “Title of Invention,” and so forth. It will be appreciated that actual values corresponding to the specific IP being announced will be inserted below in connection with step 230. It will also be appreciated that in some embodiments the template may have additional items such as, for example, a generic greeting, announcement, links or the like.

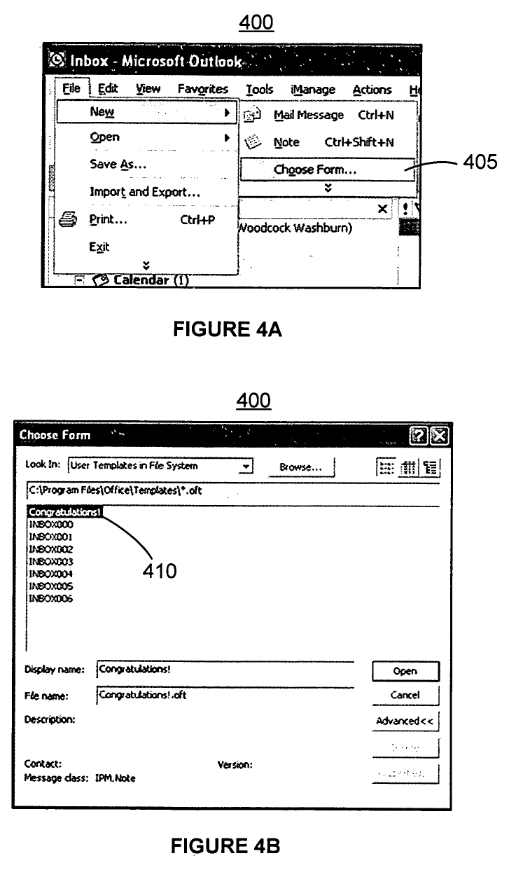

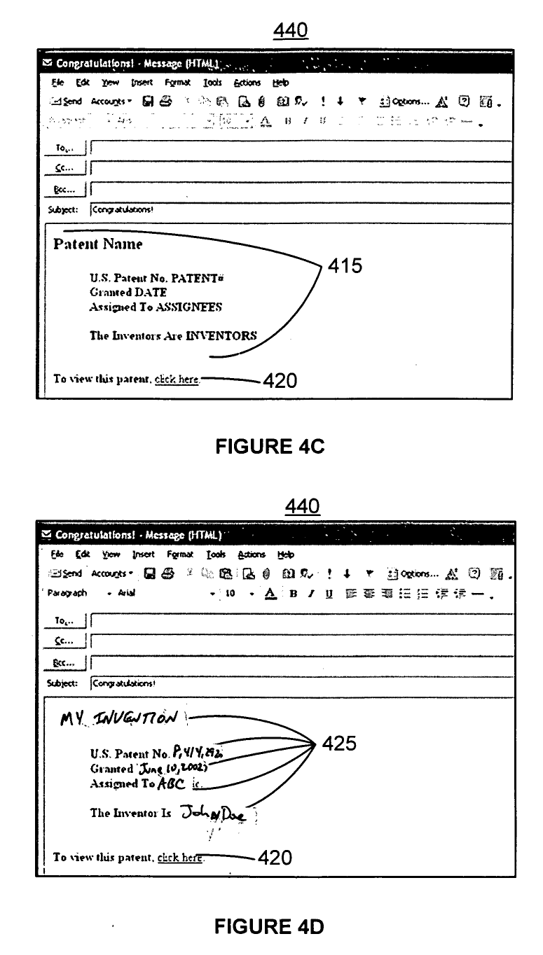

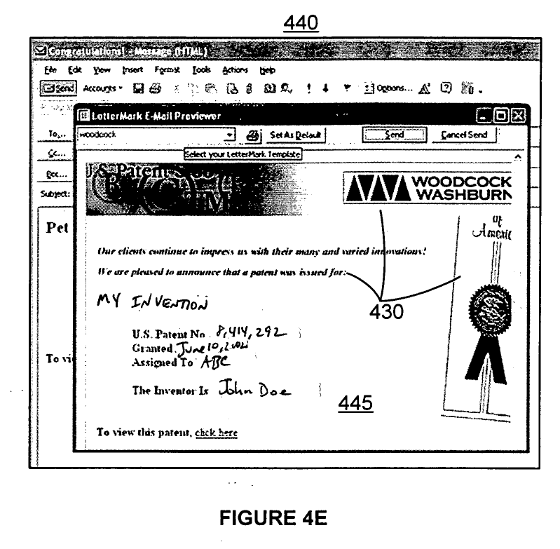

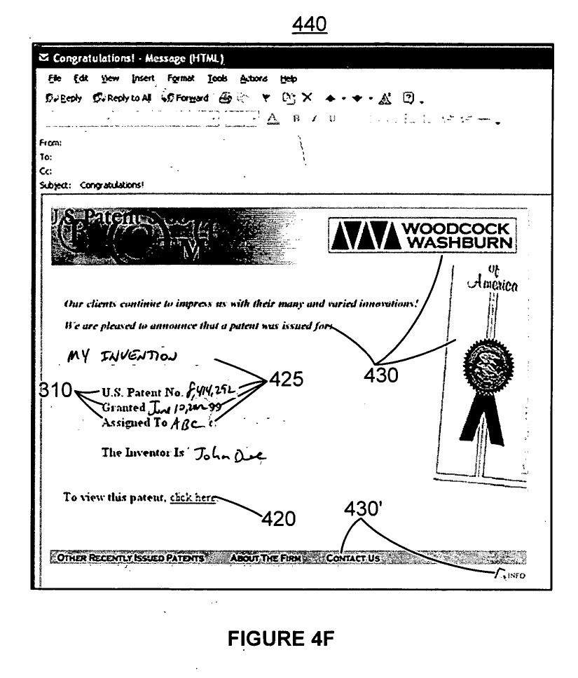

At step 225, an email is opened using the template created in step 220. Such a step will be discussed in greater detail in connection with FIGS. 4A-C. As may be appreciated, the email at this point contains the generalized IP information that was created in step 220. At step 230, therefore, the email is edited to insert the specific information relating to the issued IP. For example, next to “IP Number” the actual IP number of the issued IP (e.g., U.S. Pat. No. 6,123,456) may be inserted, along with other specific information about the IP. As may be appreciated, additional information not related to the generalized information created at step 220 may also be inserted. In one embodiment, the generalized information of step 220 may also be edited, deleted or the like to create a customized email message.

Once the email has been edited, a link is attached at step 250. It will be appreciated that the link may be to the electronic copy of the issued IP, to the web site in which the copy is stored, or to any other electronic location that is related to the web site and/or issued IP. For example, in one embodiment a link to an IP firm's web site is attached. When a user activates (or “clicks”) the link, the IP firm's web site is presented to the user on, for example, the display device 106 of computer 100 (not shown in FIG. 2 for clarity). In another embodiment, clicking the link causes the electronic copy of the IP to be displayed on the display device. It will be appreciated that the link may take any form. For example, the link may be a graphical image such as, for example, an icon, or may simply be the text of the hyperlink (e.g., www.woodcock.com/issued_IP.html). The link may also be animated using video and/or sound.

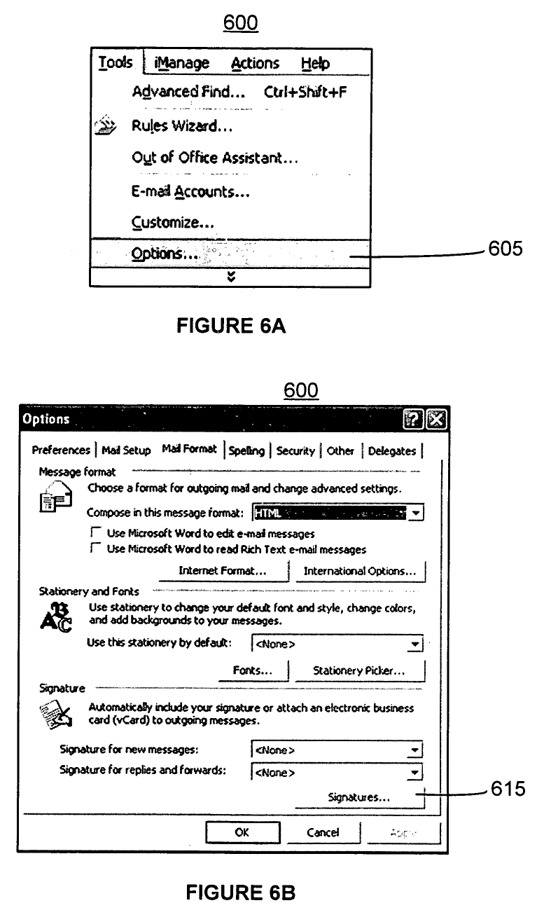

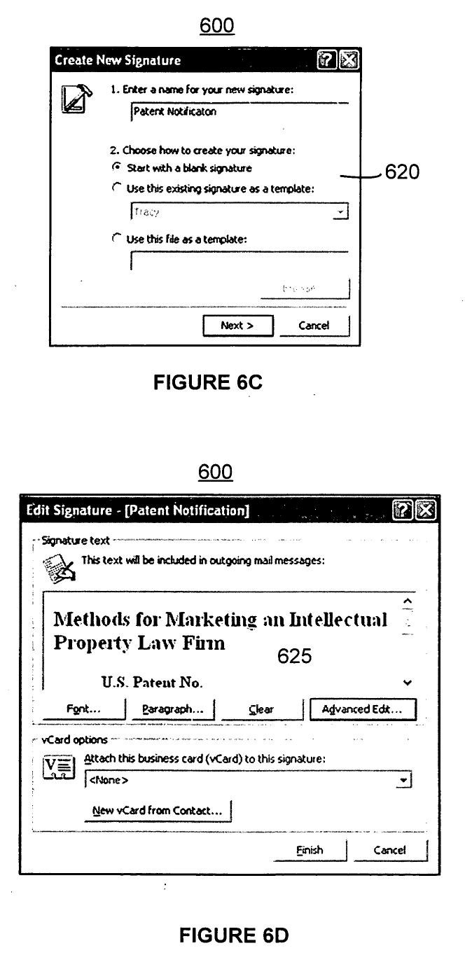

If, however, at step 215 a determination was made that the email is to be generated with an email signature, the method proceeds to step 235 instead. At step 235, and as will be discussed in greater detail in connection with FIGS. 6A-D below, an email signature containing, for example, generalized IP information is created and stored. It will be appreciated that—as was the case with the template, above—in some embodiments the email may have additional text such as, for example, a generic greeting, announcement or the like.

The generalized IP information may be the same type of information discussed above in connection with step 220. Likewise, it will be appreciated that step 235, as indicated by the dotted lines, need only be performed one time to create the signature. After such a time, step 235 can be skipped, as the already-created signature will be available to a user to select and open in step 240, below.

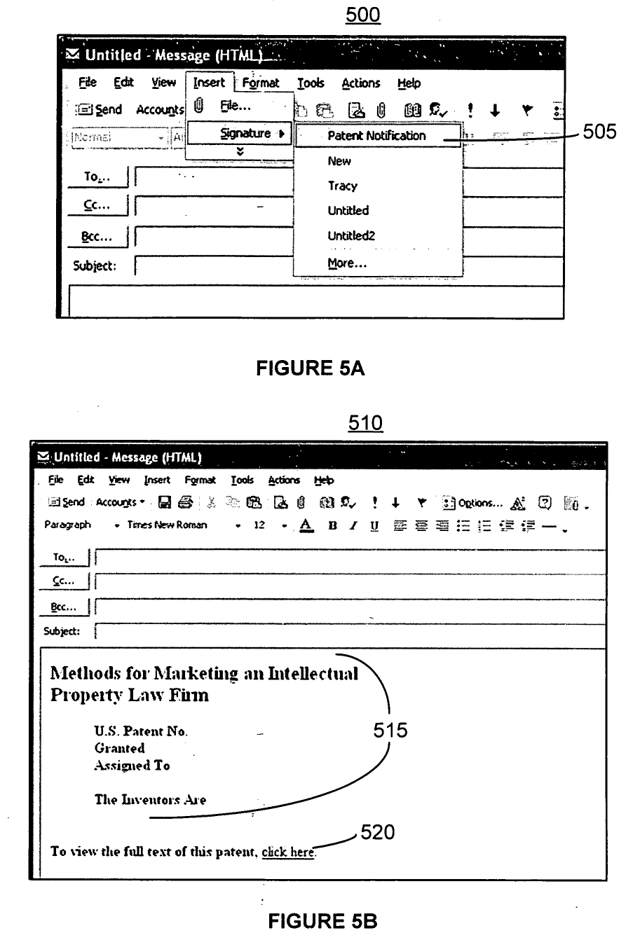

At step 240, an email having the signature is opened and edited. As may be appreciated, and as will be discussed in connection with FIGS. 5A-B below, the signature may be included in the email automatically once it is opened, or the signature may be selected by the user and inserted into a blank email. Any such operation is equally consistent with an embodiment of the present invention. At step 245, therefore, the signature is edited in much the same manner as the template as discussed above in connection with step 230. For example, specific IP information may be added, the signature may be edited and the like. Once the editing of step 245 is complete, the method proceeds to step 250 as discussed above.

At optional step 255, additional elements may be added to the email. For example, in one embodiment a graphics background is inserted into the email to give the email a more professional and high-quality look. The graphics may be the IP firm's logo, illustrations, a figure from the IP and/or the like. In addition, sounds, video, links and any other type of media may be inserted into the email. As may be appreciated, any format of such elements is equally consistent with an embodiment of the present invention.

Finally, at step 260, the email is sent to one or more intended recipients. As may be appreciated, the recipient(s) may be any person or organization associated with the IP firm. For example, in one embodiment the recipient may be the inventors and/or client, potential clients, colleagues and the like. As may also be appreciated, the transmitted email is in condition for a recipient to read the text in the email and to click on the link to display the electronic copy of the issued IP or the web site associated with the IP firm.

Turning now to FIGS. 3-6, a series of screen shots illustrating exemplary methods of creating a template and signature, and creating an email using each, is illustrated. It will be appreciated that while FIGS. 3-6 illustrate various portions of the method of FIG. 2 in the context of Microsoft® Outlook®, any email program or editor may be used, and any such program or editor is equally consistent with an embodiment of the present invention.

Referring now to FIGS. 3A-B, one exemplary method of creating a template in accordance with one embodiment of the present invention is illustrated in two screen shots. As may be appreciated, FIGS. 3A-B correspond to step 220 as discussed above in connection with FIG. 2. In FIG. 3A, a user interface 300 displays an email message within which a user can create a template. It will be appreciated that the user interface 300 can take any form, as an embodiment of the present invention is equally compatible with any such user interface 300. Within the user interface 300 is a selection 305, whereby a user can select such selection 305 to save the template. As can be seen in FIG. 3A, generalized IP information 310 such as, for example, “U.S. IP No.” has been inserted, as well as an optional placeholder (“IP#”) for specific IP information to be added later. In addition, a link 315 has been inserted. As can be seen in FIG. 3A, the link in one embodiment is simply the underlined words, “click here,” although as noted above a link can take any form.

Referring now to FIG. 3B, a screen shot of a user interface 300 presenting options 320 for saving the template created in the user interface 300 of FIG. 3A, above, is shown. Again, it will be appreciated that any such configuration of options 320 is consistent with an embodiment of the present invention. Thus, at the completion of saving the template by using the options 320 presented by the user interface 300 of FIG. 3B, a template is ready for use in the remainder of the method described above in connection with FIG. 2.

In FIGS. 4A-F, a series of screen shots illustrating an exemplary method of generating an email using a template—which corresponds to steps 225-230 and 250-260 of FIG. 2, above—is illustrated. Turning now to FIG. 4A, a user interface 400 is shown that provides a user with options 405 as to which template to choose. As was the case with FIGS. 3A-B, above, any type of options 405 or user interface 400 is consistent with an embodiment of the present invention. Referring now to FIG. 4B, a template 410 is selected by way of the user interface 400. Turning now to FIG. 4C, an email 440 that is formatted with the template 410 (not shown in FIG. 4C for clarity) is illustrated. As can be seen in FIG. 4C, generalized IP information 415 and a link 420 have been inserted into the email 440 according to the template 410.

Referring now to FIG. 4D, a screen shot of the email 440 with specific information 425 inserted therein is illustrated. As can be seen, the link 420 is unchanged, although in some embodiments the link is changed to reflect the exact location of the electronic copy of the issued IP. The specific information 425 such as, for example, “U.S. Pat. No. 5,901,666,” referring to the IP number of the issued IP, has been entered by a user or automatically using, for example, a predetermined process.

Turning now to FIG. 4E, a screen shot of a preview 445 of the email 440 is illustrated. As can be seen in FIG. 4E, the preview 445 contains graphics 430 that have been inserted. As may be appreciated, such an insertion of graphics may take place as part of the email program, or as part of a second program such as, for example LetterMark™ by FullSeven Technologies, Inc.

Referring now to FIG. 4F, a screen shot of an exemplary email created in accordance with one embodiment of the present invention is illustrated. As can be seen in FIG. 4F, email 440 contains generalized IP information 310, specific IP information 425 and a link 420. Email 440 contains additional elements such as graphics 430 and 430′. As can be seen, graphics 430′ contains additional links that can be directed to any type of content. Thus, it will be appreciated that the graphics 430 and 430′ may be any form of email content that may be passively viewed by a user, or that may allow user interaction. For example, such graphics 430 and 430′ may contain a sound, animation, a link and/or the like.

In FIGS. 5A-B, a series of screen shots illustrating an exemplary use of an email signature to generate an email in accordance with one embodiment of the present invention is provided. As may be appreciated, FIGS. 5A-B correspond to step 240 of FIG. 2, above. In FIG. 5A, a user interface 500 containing an email is illustrated. As can be seen in FIG. 5A, a selection 505 is provided wherein a user can interact with the interface 500 to generate a signature to be placed within the email. It will be appreciated that in some embodiments the signature may be placed in the email automatically so that the selection 505 is unnecessary. Referring now to FIG. 5B, an email 510 that has been formatted with the signature is illustrated. As can be seen in FIG. 5B, the email 510 includes generalized IP information 515 as well as a link 520. As will be appreciated, the remainder of the method of generating an email in accordance with an embodiment of the present invention may take place in a manner similar to that described above in connection with FIGS. 4D-F, and is therefore omitted herein for clarity.

In FIGS. 6A-D, a series of screenshots depicting an exemplary creation of an email signature in accordance with one embodiment of the present invention is provided. As may be appreciated, the steps illustrated in FIGS. 6A-D correspond to step 235 of FIG. 2, above. Turning now to FIG. 6A, a user interface 600 is illustrated that comprises a selection 605 for creating a signature. Upon activating the selection 605 of FIG. 6A, a user will see the user interface of FIG. 6B. Referring now to FIG. 6B, within the user interface 600 is a button 615 for creating a signature. As may be appreciated, the manner in which a user indicates a desire to create a signature may take any form such as, for example, a button (as shown in FIG. 6B), pull-down menu selection, radio button and the like.

Turning now to FIG. 6C, a third user interface 600 is illustrated. Within the user interface is a dialogue 620, which permits a user to input a name for the signature and also whether to use an existing signature or another type of file as a template for the signature. Finally, and referring now to FIG. 6D, a user interface 600 is shown that contains an edit screen 625 for entering text and the like to create the signature. It will be appreciated that the signature, once completed, can be saved so as to be used on demand, or as a default template for all future emails.

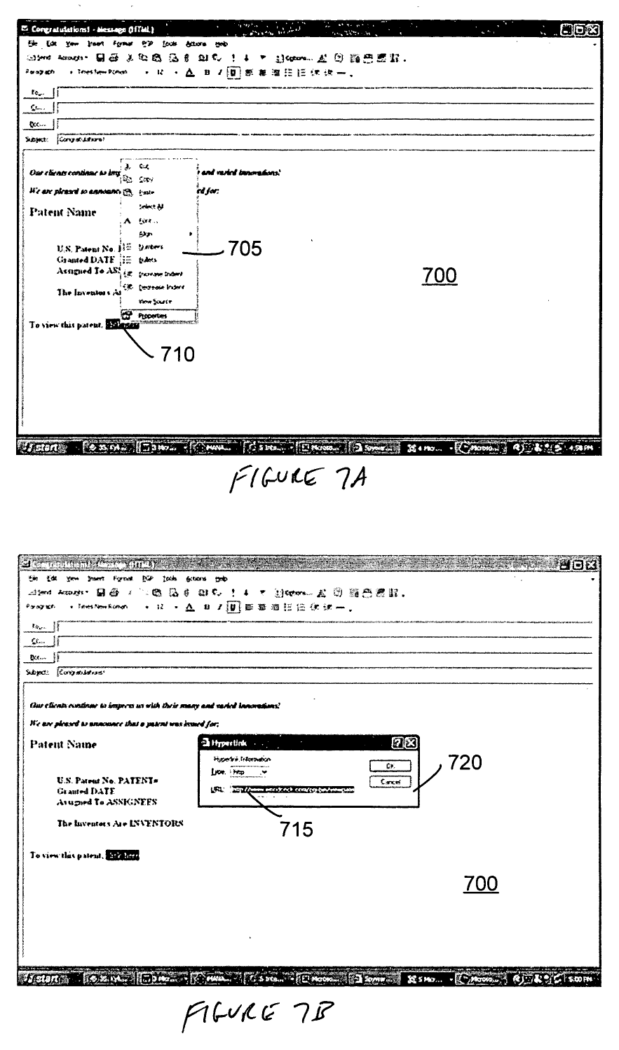

In FIGS. 7A-B, a series of screenshots depicting an exemplary creation of a link 710 to an electronic indicia of an issued intellectual property in accordance with one embodiment of the present invention is provided. A user interface 700 is illustrated that comprises a selection 705 for creating a hyperlink. Upon activating the selection 705 (e.g., by right-clicking on the link 710), a user will see the pop-up window that includes a “Properties” option. By selecting the “Properties” option, the user will be presented with an interface, such as depicted in FIG. 7B. Referring now to FIG. 7B, within the user interface 720 is a field 715 for entering an address associated with a hyperlink to the electronic indicia of the issued IP. The user may, for example, enter an address associated with the storage location of the issued IP on the IP firm's website, or to any other storage location. It will be appreciated that the hyperlink address may be saved so as to be used on demand, or as a default template for all future emails.

Thus, a method and system for marketing an IP firm has been provided. While the present invention has been described in connection with the exemplary embodiments of the various figures, it is to be understood that other similar embodiments may be used or modifications and additions may be made to the described embodiment for performing the same function of the present invention without deviating therefrom. For example, one skilled in the art will recognize that the present invention as described in the present application may apply to any configuration of email software applications or network connections. Therefore, the present invention should not be limited to any single embodiment, but rather should be construed in breadth and scope in accordance with the appended claims.

1. A method for marketing an intellectual property (IP) firm, comprising:
storing an electronic indicia of an issued IP on a web server; and
providing to a recipient an electronic notification that the IP has issued, wherein the notification includes a link to the electronic indicia of the issued IP.

2. The method of claim 1, further comprising:
storing the electronic indicia on a web server associated with the IP firm.

3. The method of claim 1, wherein the IP is at least one of a patent, a trademark, and a copyright.

4. The method of claim 1, wherein the IP is a patent.

5. The method of claim 1, wherein the electronic notification includes a link to a web site associated with the IP firm.

6. The method of claim 1, further comprising:
identifying that the IP has issued prior to storing the electronic indicia.

7. The method of claim 1, wherein providing the electronic notification comprises:
formatting an email message with text associated with generalized IP information;
saving the email message as an email template;
opening an email formatted by the email template; and
editing the email to insert text associated with the issued IP.

8. The method of claim 1, wherein providing the electronic notification comprises:
creating an email signature that includes generalized IP information;
formatting the electronic notification with the email signature; and
editing the email signature to include text associated with the issued IP.

9. The method of claim 7, wherein the text associated with the issued IP includes at least one of an IP creator, IP name, and IP issue date.

10. The method of claim 8, wherein the text associated with the issued IP includes at least one of an IP creator, IP name, and IP issue date.

11. The method of claim 1, wherein the electronic indicia includes a .pdf file.

12. The method of claim 1, wherein the electronic notification includes an attached copy of the issued IP.

13. The method of claim 1, wherein the electronic notification includes graphics identifying the IP firm.

14. A method for marketing an intellectual property (IP) firm, comprising:
storing an electronic indicia of an issued IP on a web server;
presenting the electronic indicia on a web site associated with the IP firm; and
providing an email notification that the IP has issued, wherein the email notification has a link to the web site.

15. The method of claim 14, wherein the link is to a first page of the web site and the electronic indicia is presented on a second page of the web site.

16. The method of claim 14, further comprising identifying that the IP has issued prior to storing the electronic indicia.

17. The method of claim 14, wherein providing the email notification further comprises:
formatting an email message with text associated with generalized IP information;
saving the email message as an email template;
opening an email formatted by the email template; and
editing the email to insert text associated with the issued IP.

18. The method of claim 14, wherein providing the email notification further comprises:
creating an email signature that includes generalized IP information;
formatting the electronic notification with the email signature; and
editing the email signature to include text associated with the issued IP.

19. The method of claim 17, wherein the text associated with the issued IP includes at least one of an IP creator, an IP name, and an IP issue date.

20. The method of claim 18, wherein the text associated with the issued IP includes at least one of an IP creator, an IP name, and an IP issue date.

21. The method of claim 14, wherein the electronic indicia includes a .pdf file.

22. The method of claim 14, wherein the electronic notification includes an attached copy of the issued IP.

23. The method of claim 14, wherein the email notification includes graphics identifying the IP firm.

24. A computer-readable medium having computer-executable instructions for performing method for marketing an intellectual property (IP) firm, the method comprising:
storing an electronic indicia of an issued IP on a web server; and
providing to a recipient an electronic notification that the IP has issued, wherein the notification includes a link to the electronic indicia of the issued IP.

25. A computer-readable medium having computer-executable instructions for performing method for marketing an intellectual property (IP) firm, comprising:
storing an electronic indicia of an issued IP on a web server;
presenting the electronic indicia on a web site associated with the IP firm; and
providing an email notification that the IP has issued, wherein the email notification has a link to the web site.
